(19) United States
(12) Patent Application Publication
(10) Pub. No.: US 2019/0292114 A1
(43) Pub. Date: Sep. 26, 2019

(54) METHOD OF MAKING FERTILIZER THROUGH ANAEROBIC DIGESTION

(71) Applicant: Penergy Solutions LLC, Huntingdon, PA (US)

(72) Inventors: Ronald E Arnoldsen, Huntingdon, PA (US); Debra A Arnoldsen, Huntingdon, PA (US)

(73) Assignee: Penergy Solutions LLC, Huntingdon, PA (US)

(21) Appl. No.: 16/364,718

(22) Filed: Mar. 26, 2019

Related U.S. Application Data
(60) Provisional application No. 62/648,022, filed on Mar. 26, 2018.

(51) Int. Cl. C05F 3/06; C05F 11/00

(52) U.S. Cl. CPC C05F 3/06; C05F 11/00

(57) ABSTRACT

Methods of making a fertilizer through the anaerobic digestion of organic matter and applying the fertilizer to plants and plant media have been developed. The method involves primarily the anaerobic digestion of food waste and animal manure, with the food waste being used in greater amounts than animal manure. The method can be applied to a variety of anaerobic digestion devices or systems implementing anaerobic digestion. After the anaerobic digestion of organic matter has occurred, liquid digestate can be separate from solid digestate, the liquid digestate can be heat pasteurized, and filtered. Thereafter, the liquid digestate can be applied as a fertilizer to plants and plant media for the promotion of plant growth, reproduction, and health.

### CROSS-REFERENCE

This application claims the benefit of U.S. Provisional Application No. 62/648,022, filed Mar. 26, 2018, which application is incorporated herein by reference.

### BACKGROUND OF THE INVENTION

Supplying plants with critical nutrients in order to enhance growth, development, and reproduction has been a mission for farmers, plantsmen, agriculturalists, and horticulturists for thousands of years. Today, primary fertilizers supply mostly three vital macronutrients: nitrogen, phosphorous, and potassium. Nitrogen is of particular importance, and is often credited as being the most important nutrient for plants, because nitrogen is a key element of chlorophyll. Nitrogen is also a vital component of amino acids that are critical for plant survival, enzymes that are involved with many biochemical reactions, and energy-transfer compounds such as adenosine triphosphate (ATP). While nitrogen is one of the most abundant elements, the inability for plants to intake nitrogen is one of the most fundamental problems that fertilizers seek to address. Even though primary fertilizers are often successful in addressing nitrogen deficiencies in traditional soils, such fertilizers often lack other beneficial nutrients that also promote plant growth, development, and reproduction. Specifically, many primary fertilizers lack important micronutrients such as iron, manganese, boron, molybdenum, copper, zinc, chlorine, and cobalt.

### SUMMARY OF THE INVENTION

The present invention includes a method of making a fertilizer in order to promote plant fertility, facilitate root, shoot, stem, flower growth, and/or enhance plant health. The fertilizer can be made, in part, from the anaerobic digestion of organic matter, wherein microbes break down organic matter in the absence of oxygen. Instead of being a manure-based fertilizer, the present invention uses organic matter that includes food wastes. Furthermore, the present invention includes placing organic matter, and water, into an anaerobic digester system in order for the organic matter to undergo microbial metabolism. After a length of time, the resulting liquid digestate, formed via anaerobic digestion, can be collected, filtered, and pasteurized before the present invention can be used as a fertilizer. The disclosed invention not only includes macronutrients, such as N, P, K, Ca, Mg, and S, but also essential micro-nutrients such as Cl, Fe, Zn, Mn, Cu, B and/or Mo. Thereby, the invention herein described can supply missing nutrients to plants that other primary fertilizers cannot.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is an exemplary illustration of a drum in which anaerobic digestion of organic matter can occur.

FIG. 2 is an exemplary illustration depicting a cross section view of a drum in which anaerobic digestion of organic matter can occur and a gondola lifting device that can be used to pull the drum through a digester body in the form of a pipe.

FIG. 3 is an exemplary illustration depicting a drum in which anaerobic digestion of organic matter can occur and sludge, which can be produced from a previous cycle.

FIG. 4 is an exemplary illustration depicting an end cap of a digester body that can house drums in which anaerobic digestion of organic matter can occur.

FIG. 5 is an exemplary illustration depicting a pump that can be used to decant liquid digestate from solid digestate.

FIG. 6 is an exemplary illustration depicting a propane tank, burner, and pasteurization drum that can be used during heat pasteurization step of the liquid digestate.

FIG. 7 is an exemplary illustration depicting a filtration device that can be used after the liquid digestate has been heat pasteurized.

FIG. 8 is an exemplary illustration depicting a storage drum and storage tote in which the liquid digestate can be contained until it is used as a fertilizer and/or plant nutrient supplement.

### DETAILED DESCRIPTION OF THE INVENTION

The present invention includes a method of making a fertilizer and/or plant nutrient supplement that can promote plant fertility, facilitate root, shoot, stem, flower growth, and/or enhance plant health. The term “fertilizer” or “plant nutrient supplement” is to be broadly construed, and can be understood to describe any collection of nutrients that can be used to promote the fertility, growth, and/or health of plants.

The fertilizer can be applied to the roots, stems, shoots, and/or leaves of containerized or field-grown plants and/or any plant media therein. For example, the fertilizer can be applied to the roots, stems, shoots, and/or leaves of plants including, but not limited to, any greenhouse, nursery, ornamental, fruit plants and/or vegetable plants. The fertilizer can be particularly useful for facilitating the fertility, growth, and/or health of crops, grasses, cannabis, and trees.

The term “plant media” is to be broadly construed, and it is understood that the term includes, but is not limited to, naturally occurring soils, soils containing additives, or mixtures thereof, and hydroponic media, and media used in aeroponic and drip irrigation systems. Common examples of naturally occurring soils are sandy soils, silty soils, clay soils, peaty soils, saline soils, and loamy soils. Such soils could be found in various geological locations where plant growth can occur such as fields, gardens, and the like. Examples of soil containing additives can include inorganic soil amendments such as lime, sulfur, gypsum, perlite, and vermiculate. Common examples of hydroponic media can include Rockwool, Lightweight Expanded Clay Aggregates, Coconut Fiber/Coconut chips, Growstones, Perlite, Peat, and Vermiculite. Common examples of aeroponic systems can include column, tower, vertical, and horizontal systems. Common examples of drip irrigation systems can include surface irrigation and sprinkler irrigation systems.

The fertilizer can contain macro-nutrients and micro-nutrients that are necessary for the promotion of plant fertility, plant health, and/or plant growth. The fertilizer can contain primary macro-nutrients including, but not limited to, nitrogen (N), phosphorus (P), and/or potassium (K), and also include secondary micro-nutrients such as calcium (Ca), magnesium (Mg), and sulfur (S). The present invention can also contain micro-nutrients including, but not limited to, chlorine (Cl), iron (Fe), zinc (Zn), manganese (Mn), copper (Cu), boron (B), and molybdenum (Mo).

The fertilizer can be used independently or in conjunction with other fertilizers. Those skilled in the art can recognize that other fertilizers contain mostly macronutrients, such as N, P and K, and often lack essential micro-nutrients such as Cl, Fe, Zn, Mn, Cu, B and/or Mo. Thereby, the fertilizer herein described can supply missing nutrients to plants that other fertilizers cannot. Since the fertilizer herein described contains both macro- and micro-nutrients, the fertilizer can promote plant health and fertility, and facilitate root, shoot, stem, and flower growth of plants.

The fertilizer can be made, in part, from the anaerobic digestion of organic matter, wherein microbes breakdown organic matter in the absence of oxygen. In some embodiments, the organic matter can be food waste and/or animal manure. Food waste can include, but is not limited to, lemons, oranges, broccoli, carrots, tomatoes, spinach, peas, cabbage, cucumbers, collard greens, kales, asparaguses, turnips, leeks, okras, chards, parsnips, green beans, artichokes, zucchinis, cauliflower, brussels sprouts, eggplant, peppers, tea bags, coffee bags, onions, lettuce, potatoes, and/or celery. Animal manure can include, but is not limited to, manures from birds, bats, rabbits, horses, goats, sheep, llamas, alpacas, cows, pigs, chickens, turkeys, ducks, and/or geese.

In some embodiments, the total volume of food waste used for anaerobic digestion can be at least about: 1.0 liter, 5.0 liters, 10.0 liters, 15.0 liters, 20.0 liters, 25.0 liters, 30.0 liters, 35 liters, 40 liters, or more liters of manure. Alternatively, the total volume of food waste used for anaerobic digestion can range from at least about: 0 liters-1.0 liters, 1.0 liters-5.0 liters, 1.0 liters-10.0 liters, 1.0 liters-15.0 liters, 1.0 liters-20.0 liters, 1.0 liters-25.0 liters, 1.0 liters-30.0 liters, 1.0 liters-35.0 liters, 1.0 liters-40.0 liters, 5.0 liters-10.0 liters, 5.0 liters-15.0 liters, 5.0 liters-20.0 liters, 5.0 liters-25.0 liters, 5.0 liters-30.0 liters, 5.0 liters-35.0 liters, 5.0 liters-40.0 liters, 10.0 liters-15.0 liters, 10.0 liters-20.0 liters, 10.0 liters-25.0 liters, 10.0 liters-30.0 liters, 10.0 liters-35.0 liters, 10.0 liters-40.0 liters, 15.0 liters-20.0 liters, 15.0 liters-25.0 liters, 15.0 liters-30.0 liters, 15.0 liters-35.0 liters, 15.0 liters-40.0 liters, 20.0 liters-25.0 liters, 20.0 liters-30.0 liters, 20.0 liters-35.0 liters, 20.0 liters-40.0 liters, 25.0 liters-30.0 liters, 25.0 liters-35.0 liters, 25.0 liters-40.0 liters, 30.0 liters-35.0 liters, 30.0 liters-40.0 liters, 35.0 liters-40.0 liters or more liters of food waste. In preferred embodiments, the total volume of food waste used for anaerobic digestion can be approximately 15.0 liters.

In some embodiments, manures of different animals can be used for anaerobic digestion in a ratio. For example, two different animal manures can be used approximately in a 1:1 ratio, 3:2 ratio, 2:1 ratio, 3:1 ratio, or 4:1 ratio. In preferred embodiments, pig manure and cow manure can be used for anaerobic digestion in approximately a 4:1 ratio.

In some embodiments, the total volume of manure or manures used for anaerobic digestion can be at least about: 1.0 liter, 2.0 liters, 3.0 liters, 4.0 liters, 5.0 liters, 6.0 liters, 7.0 liters, 8.0 liters, 9.0 liters, 10.0 liters, 11.0 liters, 12.0 liters or more liters of manure. Alternatively, the total volume of manure or manures used for anaerobic digestion can also be at least about: 0 liters-1.0 liters, 1.0 liter-2.0 liters, 1.0 liter-3.0 liters, 1.0 liter-4.0 liters, 1.0 liter-5.0 liters, 1.0 liter-6.0 liters, 1.0 liter-7.0 liters, 1.0 liter-8.0 liters, 1.0 liter-9.0 liters, 1.0 liter-10.0 liters, 1.0 liter-11.0 liters, 1.0 liter-12.0 liters, 2.0 liters-3.0 liters, 2.0 liters-4.0 liters, 2.0 liters-5.0 liters, 2.0 liters-6.0 liters, 2.0 liters-7.0 liters, 2.0 liters-8.0 liters, 2.0 liters-9.0 liters, 2.0 liters-10.0 liters, 2.0 liters-11.0 liters, 2.0 liters-12.0 liters, 3.0 liters-4.0 liters, 3.0 liters-5.0 liters, 3.0 liters-6.0 liters, 3.0 liters-7.0 liters, 3.0 liters-8.0 liters, 3.0 liters-9.0 liters, 3.0 liters-10.0 liters, 3.0 liters-11.0 liters, 3.0 liters-12.0 liters, 4.0 liters-5.0 liters, 4.0 liters-6.0 liters, 4.0 liters-7.0 liters, 4.0 liters-8.0 liters, 4.0 liters-9.0 liters, 4.0 liters-10.0 liters, 4.0 liters-11.0 liters, 4.0 liters-12.0 liters, 5.0 liters-6.0 liters, 5.0 liters-7.0 liters, 5.0 liters-8.0 liters, 5.0 liters-9.0 liters, 5.0 liters-10.0 liters, 5.0 liters-11.0 liters, 5.0 liters-12.0 liters, 6.0 liters-7.0 liters, 6.0 liters-8.0 liters, 6.0 liters-9.0 liters, 6.0 liters-10.0 liters, 6.0 liters-11.0 liters, 6.0 liters-12.0 liters, 7.0 liters-8.0 liters, 7.0 liters-9.0 liters, 7.0 liters-10.0 liters, 7.0 liters-11.0 liters, 7.0 liters-12.0 liters, 8.0 liters-9.0 liters, 8.0 liters-10.0 liters, 8.0 liters-11.0 liters, 8.0 liters-12.0 liters, 9.0 liters-10.0 liters, 9.0 liters-11.0 liters, 9.0 liters-12.0 liters, 10.0 liters-11.0 liters, 10.0 liters-12.0 liters, 10.0 liters-12.0 liters or more liters of manure. In preferred embodiments, the total volume of manure or manures used in anaerobic digestion can be approximately 7.5 liters.

In some embodiments, food waste and manure can be used in a ratio for anaerobic digestion. For example, food waste and manures can be used for anaerobic digestion approximately in a 1:1 ratio, 3:2 ratio, 2:1 ratio, 3:1 ratio, or 4:1 ratio. In preferred embodiments, food waste and manure can be used for anaerobic digestion in approximately a 2:1 ratio.

In some embodiments, water can be added to organic matter, such as food waste and manure, to help facilitate anaerobic digestion. In preferred embodiments, water can be added to food waste and manure in amounts that can be approximately two times greater than the amount of food waste used for anaerobic digestion and/or approximately five times greater than the amount of manure used for anaerobic digestion. Therefore, the particular food waste and manure ratios can affectively vary the concentration of nitrate, phosphorus, and/or calcium concentration of the fertilizer to optimal levels. In preferred embodiments, approximately 30.0 liters-40.0 liters can be added to organic matter for anaerobic digestion.

In preferred embodiments, the fertilizer can be made, in part, by adding organic matter, such as food waste and manures, and water into an anaerobic digester system. For example, an anaerobic digester system can feature parts that include, but are not limited to, a digester body that houses separate compartmentalized chambers or drums, a drum configured to receive organic matter, a plurality of drums coupled to one another, a plurality of drums that are movable along a length of the digester body, and/or a plurality of ports spaced along the digester body and arranged to vent biogas from the digester body. As a result, the food waste and manure can undergo microbial metabolism, e.g., in the form of hydrolysis, acidogenesis, acetogenesis, and/or methanogenesis, which forms two products: digestate and biogas. Thereafter, the resulting digestate can be used to make the fertilizer.

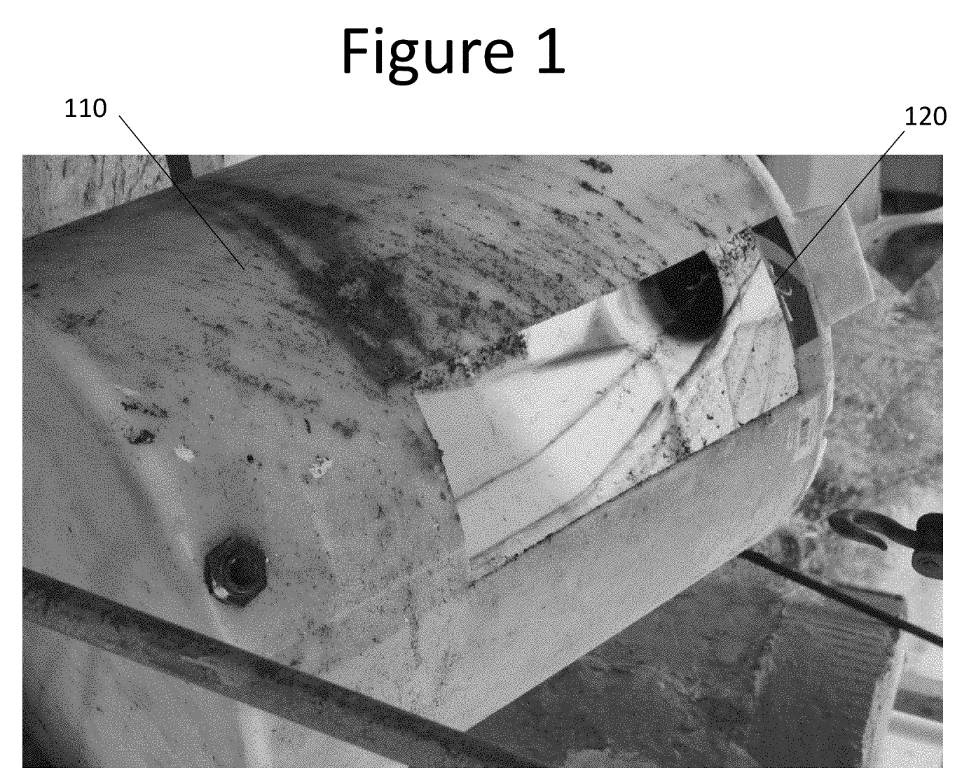

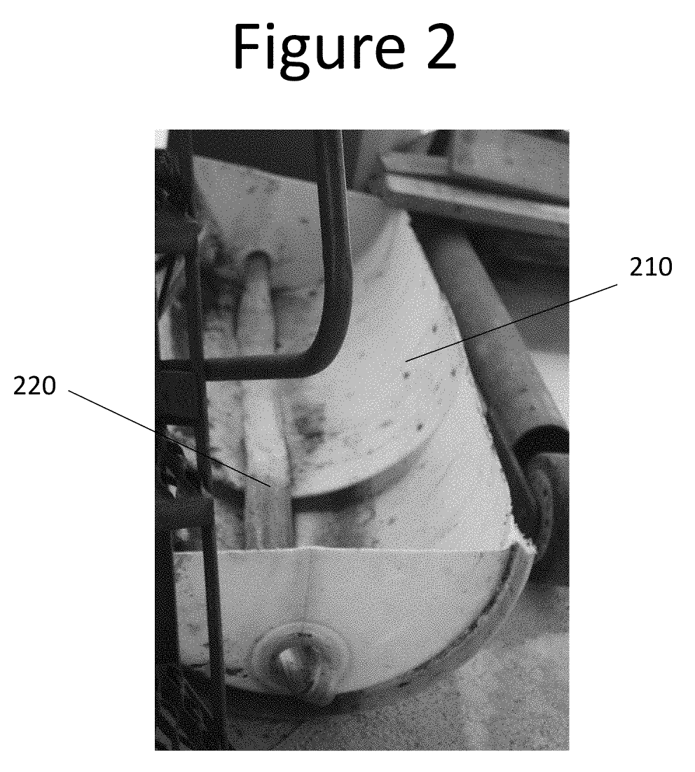

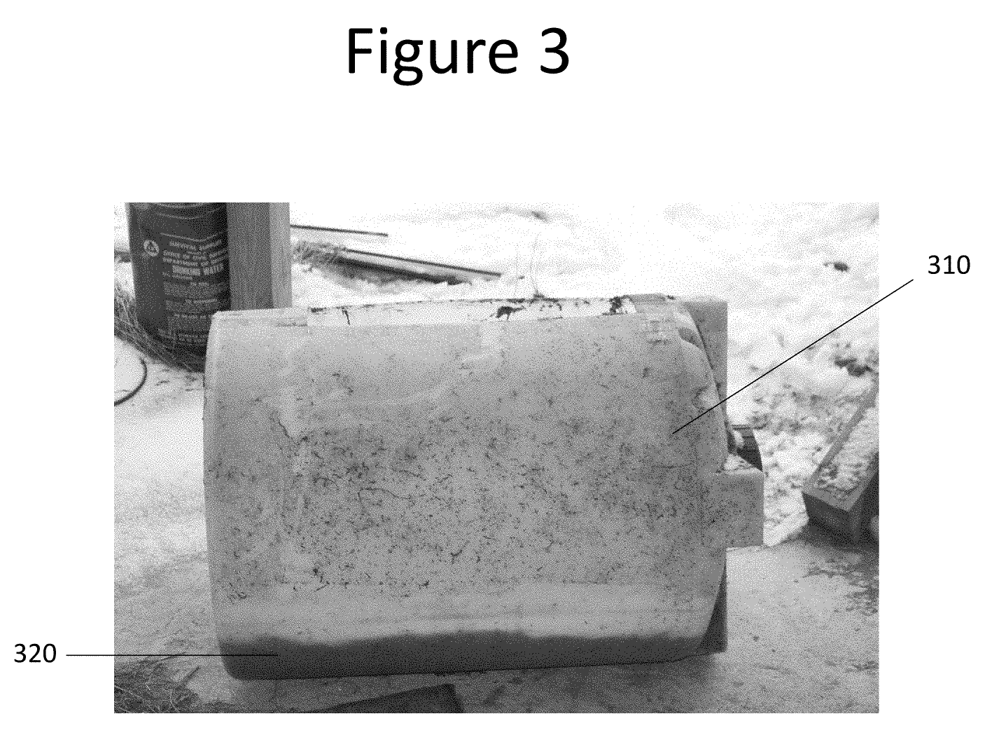

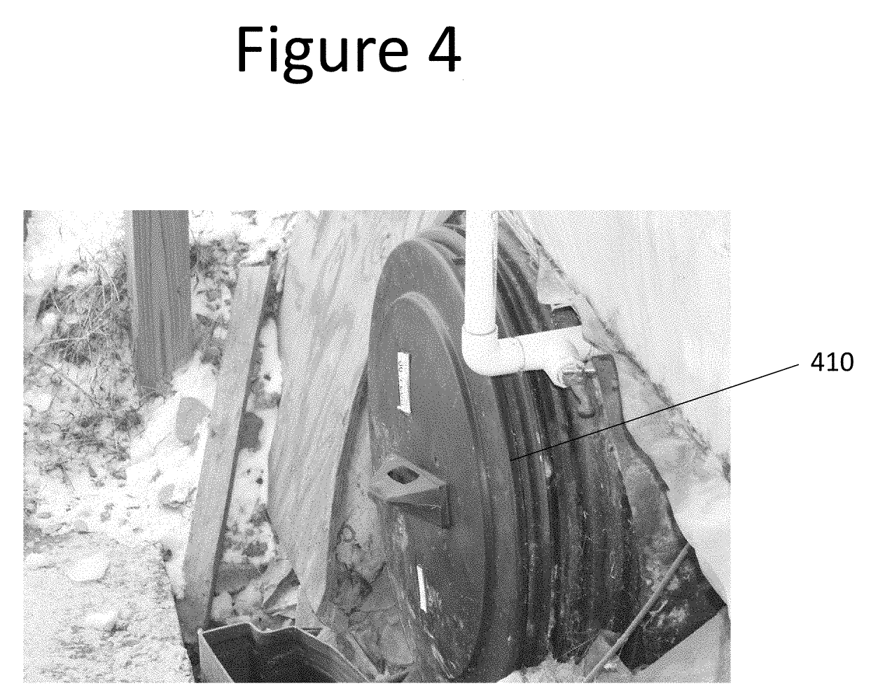

For example, in FIG. 1, organic matter, such as food waste and manure, can be placed into a drum (110) through a hole (120) or by other means. As illustrated in FIG. 2, a drum (210) can contain a gondola device (220) that can be used to pull other drums through a digester body. Therefore, the gondola device (220) can connect multiple drums containing organic matter together and allow the drums to be pulled out of the digester body. As illustrated in FIG. 3, a drum (310) may include sludge (320) from previous cycles, and as a result, the drum (310) can contain a mixture of food waste, manure, sludge, and water. As illustrated in FIG. 4, a digester body, which houses the drums, can contain an outside end cap (410) that can be removed and can therefore enable a drum to be removed from the digester body.

In some embodiments, organic matter can be left in a drum for at least about: 30 days, 45 days, 60 days, 75 days, 90 days, 105 days, 120 days or more days. Alternatively, organic matter can be left in a drum in a range for at least about: 15 days-30 days, 15 days-45 days, 15 days-60 days, 15 days-75 days, 15 days-90 days, 15 days-105 days, 15 days-120 days, 30 days-45 days, 30 days-60 days, 30 days-75 days, 30 days-90 days, 30 days-105 days, 30 days-120 days, 45 days-60 days, 45 days-75 days, 45 days-90 days, 45 days-105 days, 45 days-120 days, 60 days-75 days, 60 days-90 days, 60 days-105 days, 60 days-120 days, 75 days-90 days, 75 days-105 days, 75 days-120 days, 90 days-105 days, 90 days-120 days, 105 days-120 days, or more days. In preferred embodiments, organic matter can be left in a drum for 60 days-75 days.

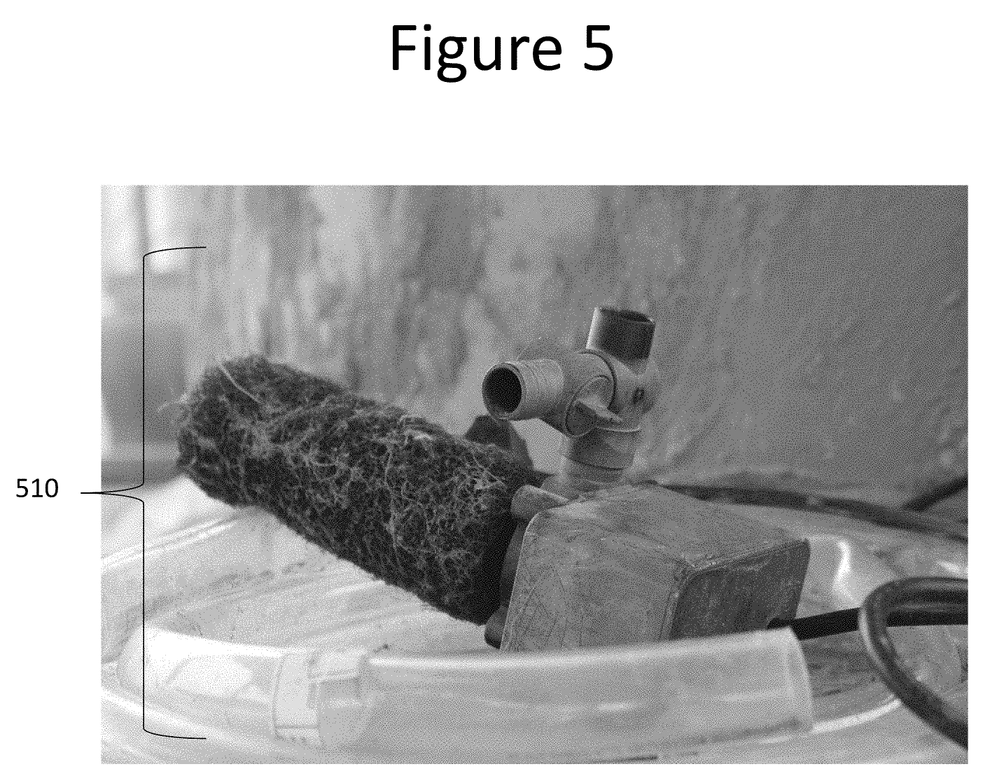

In preferred embodiments, after an adequate amount of time has passed for anaerobic digestion to occur, the resulting liquid digestate can be separated from the solid digestate. Thereby, the liquid digestate can be collected for subsequent use as a fertilizer. In some embodiments, the liquid digestate can be separated from the solid digestate via decantation. The method of decantation can be achieved in a variety of ways that can be recognized by those skilled in the art. For example, in FIG. 5, decantation can be achieved by using a pump (510) to separate the liquid digestate from the solid digestate. The types of pumps that can be used for decantation include, but are not limited to, positive displacement and centrifugal pumps. For example, positive displacement pumps can include, but are not limited to, progressive cavity, twin-screw, rotary and/or reciprocating positive displacement pumps. Alternatively, centrifugal pumps can include, but are not limited to, electric submersible and/or helicon-axial pumps. Such pumps can operate through various energy sources including, but not limited to, electricity, engines, and/or wind power.

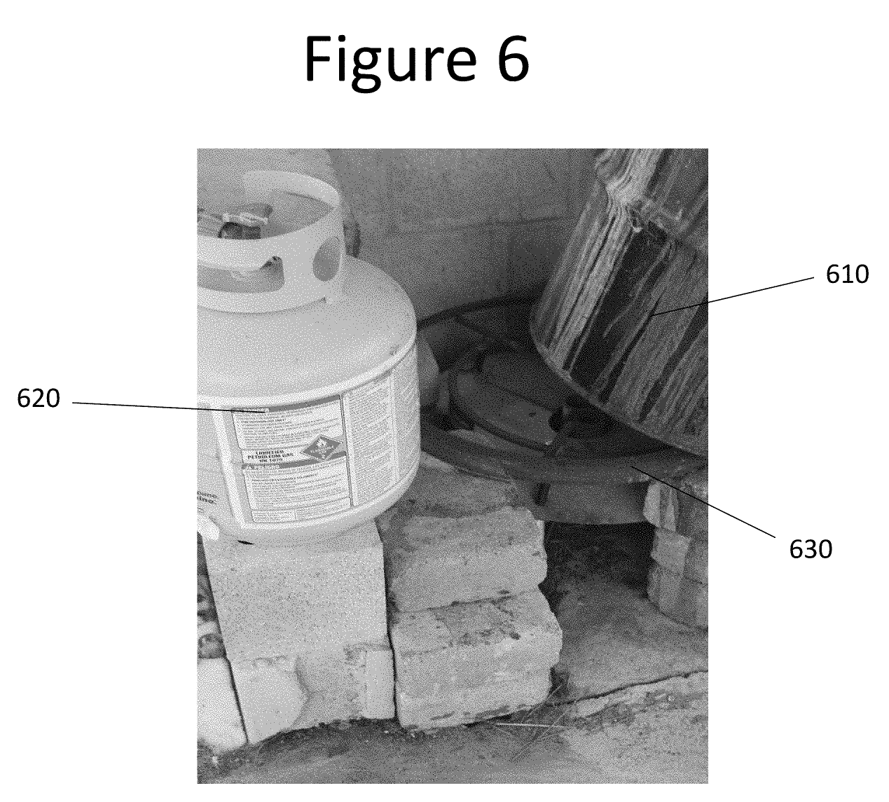

In some embodiments, heat pasteurization can be applied to the liquid digestate after separation from the solid digestate has occurred. The heat pasteurization process can destroy pathogens, and thereby, make the liquid digestate safe to apply on plants used for food production. The heat pasteurization process can occur by applying heat to the liquid digestate and can include, but is not limited to, heating methods that involve heating the liquid digestate through the use of natural gas and/or propane heating systems. For example, in FIG. 6, a propone tank (620) can act as an energy source for a burner (630) in order to heat the liquid digestate. In preferred embodiments, the liquid digestate can be heated after the liquid digestate has previously been decanted into a pasteurization drum (610).

The liquid digestate can be heated to a temperature of at least about: 90° C., 95° C., 100° C., 105° C., 110, 115° C., 120° C. or more degrees Celsius. Alternatively, the liquid digestate can be heated to temperature ranges of at least about: 90° C.-95° C., 90° C.-100° C., 90° C.-105° C., 90° C.-110° C., 90° C.-115° C., 90° C.-120° C., 95° C.-100° C., 95° C.-105° C., 95° C.-110° C., 95° C.-115° C., 95° C.-120° C., 100° C.-105° C., 100° C.-110° C., 100° C.-115° C., 100° C.-120° C., 105° C.-110° C., 105° C.-115° C., 105° C.-120° C., 110° C.-115° C., 110° C.-120° C., 110° C.-120° C. or more degrees Celsius. In preferred embodiments, the liquid digestate can be heated to approximately 100° C. by using a burner with an electrical power capacity of at least about 4.0 kilowatts.

In some embodiments, the liquid digestate can be heated to the aforementioned temperatures and/or temperature ranges for a time of at least about: 10 minutes, 20 minutes, 30 minutes, 40 minutes, 45 minutes, 50 minutes, 60 minutes, 70 minutes, 80 minutes, 90 minutes, 100 minutes, 110 minutes, 120 minutes or more minutes. Alternatively, the liquid digestate can be heated for a time of at least about: 10 minutes-20 minutes, 10 minutes-30 minutes, 10 minutes-40 minutes, 10 minutes-50 minutes, 10 minutes-60 minutes, 10 minutes-70 minutes, 10 minutes-80 minutes, 10 minutes-90 minutes, 10 minutes-100 minutes, 10 minutes-110 minutes, 10 minutes-120 minutes, 20 minutes-30 minutes, 20 minutes-40 minutes, 20 minutes-50 minutes, 20 minutes-60 minutes, 20 minutes-70 minutes, 20 minutes-80 minutes, 20 minutes-90 minutes, 20 minutes-100 minutes, 20 minutes-110 minutes, 20 minutes-120 minutes, 30 minutes-40 minutes, 30 minutes-50 minutes, 30 minutes-60 minutes, 30 minutes-70 minutes, 30 minutes-80 minutes, 30 minutes-90 minutes, 30 minutes-100 minutes, 30 minutes-110 minutes, 30 minutes-120 minutes, 40 minutes-50 minutes, 40 minutes-60 minutes, 40 minutes-70 minutes, 40 minutes-80 minutes, 40 minutes-90 minutes, 40 minutes-100 minutes, 40 minutes-110 minutes, 40 minutes-120 minutes, 50 minutes-60 minutes, 50 minutes-70 minutes, 50 minutes-80 minutes, 50 minutes-90 minutes, 50 minutes-100 minutes, 50 minutes-110 minutes, 50 minutes-120 minutes, 60 minutes-70 minutes, 60 minutes-80 minutes, 60 minutes-90 minutes, 60 minutes-100 minutes, 60 minutes-110 minutes, 60 minutes-120 minutes, 70 minutes-80 minutes, 70 minutes-90 minutes, 70 minutes-100 minutes, 70 minutes-110 minutes, 70 minutes-120 minutes, 80 minutes-90 minutes, 80 minutes-100 minutes, 80 minutes-110 minutes, 80 minutes-120 minutes, 90 minutes-100 minutes, 90 minutes-110 minutes, 90 minutes-120 minutes, 100 minutes-110 minutes, 100 minutes-110 minutes, 100 minutes-120 minutes, 110 minutes-120 minutes or more minutes. In preferred embodiments, the liquid digestate can be heated for approximately 20 minutes-30 minutes.

In some embodiments, the heated liquid digestate can be stirred during pasteurization at least about every: 10 minutes, 20 minutes, 30 minutes, 40 minutes, 50 minutes or more. Alternatively, the heated liquid digestate can be stirred during pasteurization at least about every: 10 minutes-20 minutes, 10 minutes-30 minutes, 10 minutes-40 minutes, 10 minutes-50 minutes, 20 minutes-30 minutes, 20 minutes-40 minutes, 20 minutes-50 minutes, 30 minutes-40 minutes, 30 minutes-50 minutes, 40 minutes-50 minutes or more minutes.

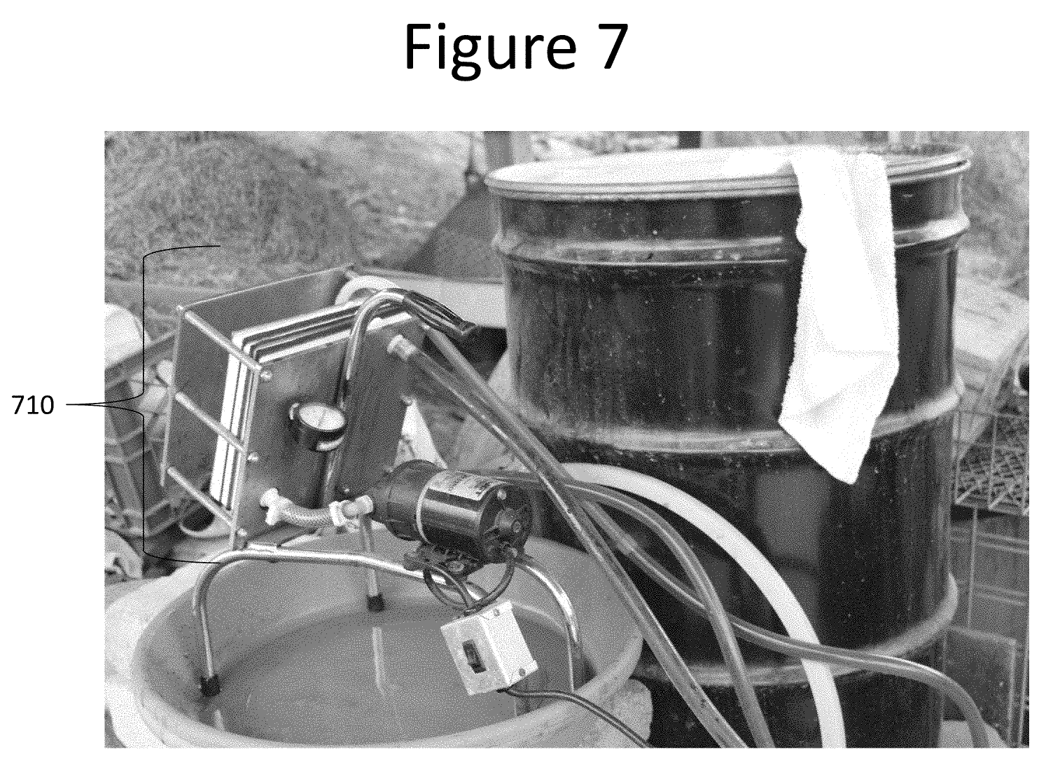

In preferred embodiments, after heat pasteurization has occurred, the liquid digestate can undergo filtration. Thereby, any unwanted and/or remaining particulate matter that has remained in the liquid digestate can be separated from the liquid digestate. For example, in FIG. 7, a filter device (710) can be used to further clarify and filter the liquid digestate. Filtration can be completed by using certain pumps that can include, but are not limited to, peristaltic, volumetric, centrifugal, and/or any pumps that can be advantageous for wine filtration. Peristaltic pumps can be particularly useful for filtration because the peristaltic pump can enable the delicate separation of the liquid digestate from unwanted particulate matter and can be self-priming. Furthermore, peristaltic pumps do not introduce any oxygen to the liquid digestate. Volumetric pumps are also advantageous to use for filtration purposes because volumetric pumps can separate gently thin and highly viscous liquid products that contain solids from the liquid digestate. In preferred embodiments, the liquid digestate can be allowed to cool for 24 hours before filtration begins.

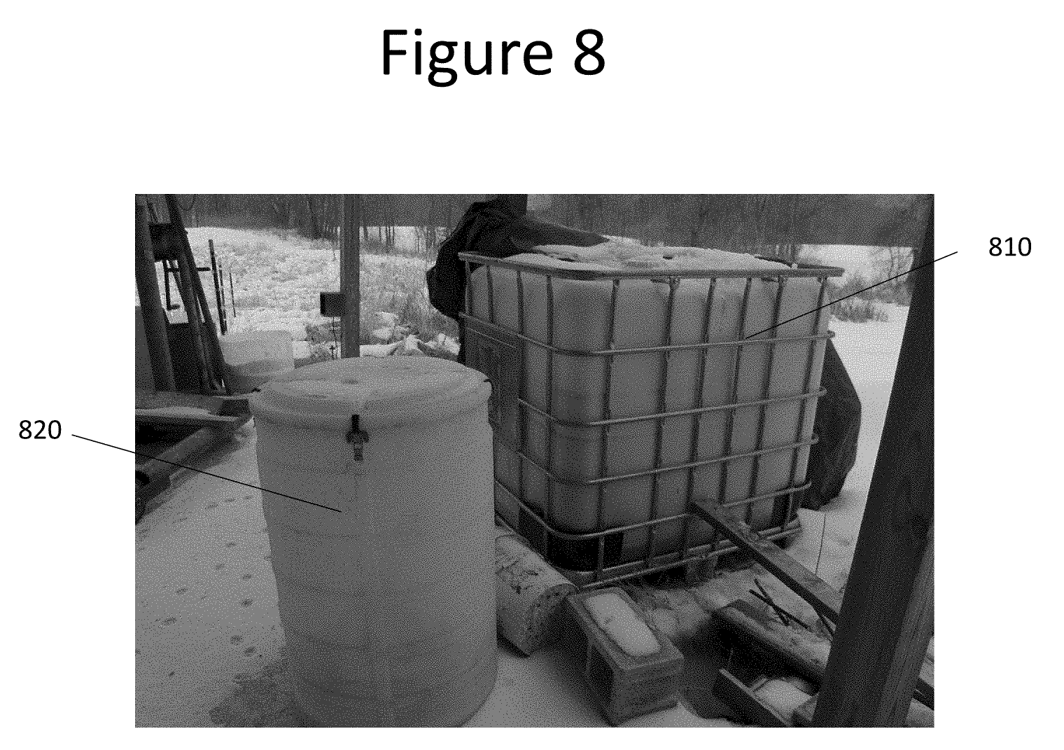

In some embodiments, after the filtration of the liquid digestate has been completed, the liquid digestate can be used directly as a fertilizer and/or plant nutrient supplement. For example, in FIG. 8, the liquid digestate can be filtrated into a storage drum (820), storage tote (810), or any other storage unit until the invention is needed.

The composition of the fertilizer can be comprised of at least about: 0.0100%, 0.0125%, 0.0150%, 0.0175%, 0.0200%, 0.0225%, 0.0250%, 0.0275%, 0.0300%, 0.0325%, 0.0350%, 0.0375%, 0.04%, 0.045%, 0.05% or more of total nitrogen. Alternatively, the composition of the fertilizer can be comprised of at least about: 0%-0.0100%, 0.0100%-0.0125%, 0.0100%-0.0150%, 0.0100%-0.0175%, 0.0100%-0.0200%, 0.0100%-0.0225%, 0.0100%-0.0250%, 0.0100%-0.0275%, 0.0100%-0.0300%, 0.0100%-0.0325%, 0.0100%-0.0350%, 0.0100%-0.0375%, 0.0100%-0.0400%, 0.0125%-0.0150%, 0.0125%-0.0175%, 0.0125%-0.0200%, 0.0125%-0.0225%, 0.0125%-0.0250%, 0.0125%-0.0275%, 0.0125%-0.0300%, 0.0125%-0.0325%, 0.0125%-0.0350%, 0.0125%-0.0375%, 0.0125%-0.0400%, 0.0150%-0.0175%, 0.0150%-0.0200%, 0.0150%-0.0225%, 0.0150%-0.0250%, 0.0150%-0.0275%, 0.0150%-0.0300%, 0.0150%-0.0325%, 0.0150%-0.0350%, 0.0150%-0.0375%, 0.0150%-0.0400%, 0.0175%-0.0200%, 0.0175%-0.0225%, 0.0175%-0.0250%, 0.0175%-0.0275%, 0.0175%-0.0300%, 0.0175%-0.0325%, 0.0175%-0.0350%, 0.0175%-0.0375%, 0.0175%-0.0400%, 0.0200%-0.0225%, 0.0200%-0.0250%, 0.0200%-0.0275%, 0.0200%-0.0300%, 0.0200%-0.0325%, 0.0200%-0.0350%, 0.0200%-0.0375%, 0.0200%-0.0500%, 0.0225%-0.0250%, 0.0225%-0.0275%, 0.0225%-0.0300%, 0.0225%-0.0325%, 0.0225%-0.0350%, 0.0225%-0.0375%, 0.0225%-0.0400%, 0.0250%-0.0275%, 0.0250%-0.0300%, 0.0250%-0.0325%, 0.0250%-0.0350%, 0.0250%-0.0375%, 0.0250%-0.0400%, 0.0275%-0.0300%, 0.0275%-0.0325%, 0.0275%-0.0350%, 0.0275%-0.0375%, 0.0275%-0.0400%, 0.0300%-0.0325%, 0.0300%-0.0350%, 0.0300%-0.0375%, 0.0300%-0.0400%, 0.0325%-0.0350%, 0.0325%-0.0375%, 0.0325%-0.0500%, 0.0350%-0.0375%, 0.0350%-0.0500%, 0.0375%-0.0500% or more total nitrogen.

The composition of the fertilizer can be comprised of at least about: 0.0100%, 0.0125%, 0.0150%, 0.0175%, 0.0200%, 0.0225%, 0.0250%, 0.0275%, 0.0300%, 0.0325%, 0.0350%, 0.0375%, 0.04%, 0.045%, 0.05% or more of water soluble nitrogen. Alternatively, the composition of the fertilizer can be composed of at least about: 0%-0.0100%, 0.0100%-0.0125%, 0.0100%-0.0150%, 0.0100%-0.0175%, 0.0100%-0.0200%, 0.0100%-0.0225%, 0.0100%-0.0250%, 0.0100%-0.0275%, 0.0100%-0.0300%, 0.0100%-0.0325%, 0.0100%-0.0350%, 0.0100%-0.0375%, 0.0100%-0.0400%, 0.0125%-0.0150%, 0.0125%-0.0175%, 0.0125%-0.0200%, 0.0125%-0.0225%, 0.0125%-0.0250%, 0.0125%-0.0275%, 0.0125%-0.0300%, 0.0125%-0.0325%, 0.0125%-0.0350%, 0.0125%-0.0375%, 0.0125%-0.0400%, 0.0150%-0.0175%, 0.0150%-0.0200%, 0.0150%-0.0225%, 0.0150%-0.0250%, 0.0150%-0.0275%, 0.0150%-0.0300%, 0.0150%-0.0325%, 0.0150%-0.0350%, 0.0150%-0.0375%, 0.0150%-0.0500%, 0.0175%-0.0200%, 0.0175%-0.0225%, 0.0175%-0.0250%, 0.0175%-0.0275%, 0.0175%-0.0300%, 0.0175%-0.0325%, 0.0175%-0.0350%, 0.0175%-0.0375%, 0.0175%-0.0500%, 0.0200%-0.0225%, 0.0200%-0.0250%, 0.0200%-0.0275%, 0.0200%-0.0300%, 0.0200%-0.0325%, 0.0200%-0.0350%, 0.0200%-0.0375%, 0.0200%-0.0500%, 0.0225%-0.0250%, 0.0225%-0.0275%, 0.0225%-0.0300%, 0.0225%-0.0325%, 0.0225%-0.0350%, 0.0225%-0.0375%, 0.0225%-0.0400%, 0.0250%-0.0275%, 0.0250%-0.0300%, 0.0250%-0.0325%, 0.0250%-0.0350%, 0.0250%-0.0375%, 0.0250%-0.0400%, 0.0275%-0.0300%, 0.0275%-0.0325%, 0.0275%-0.0350%, 0.0275%-0.0375%, 0.0275%-0.0400%, 0.0300%-0.0325%, 0.0300%-0.0350%, 0.0300%-0.0375%, 0.0300%-0.0400%, 0.0325%-0.0350%, 0.0325%-0.0375%, 0.0325%-0.0500%, 0.0350%-0.0375%, 0.0350%-0.0400%, 0.0375%-0.0500% or more water soluble nitrogen.

The composition of the fertilizer can be comprised of at least about: 0.000300%, 0.000400%, 0.000500%, 0.000600%, 0.000700%, 0.000800%, 0.000900%, 0.00100%, 0.00200%, 0.00300% or more of water insoluble nitrogen. Alternatively, the composition of the fertilizer can be comprised of at least about: 0%-0.000300%, 0.000300%-0.000400%, 0.000300%-0.000500%, 0.000300%-0.000600%, 0.000300%-0.000700%, 0.000300%-0.000800%, 0.000300%-0.000900%, 0.000300%-0.00100%, 0.000300%-0.00200%, 0.000300%-0.00300%, 0.000400%-0.000500%, 0.000400%-0.000600%, 0.000400%-0.000700%, 0.000400%-0.000800%, 0.000400%-0.000900%, 0.000400%-0.00100%, 0.000400%-0.00200%, 0.000400%-0.00300%, 0.000400%-0.00400%, 0.000500%-0.000600%, 0.000500%-0.000700%, 0.000500%-0.000800%, 0.000500%-0.000900%, 0.000500%-0.00100%, 0.000500%-0.00200%, 0.000500%-0.00300%, 0.000500%-0.00400%, 0.000600%-0.000700%, 0.000600%-0.000800%, 0.000600%-0.000900%, 0.000600%-0.00100%, 0.000600%-0.00200%, 0.000600%-0.00300%, 0.000600%-0.00400%, 0.000700%-0.000800%, 0.000700%-0.000900%, 0.000700%-0.00100%, 0.000700%-0.00200%, 0.000700%-0.00300%, 0.000700%-0.00400%, 0.000800%-0.000900%, 0.000800%-0.00100%, 0.000800%-0.00200%, 0.000800%-0.00300%, 0.000800%-0.00400%, 0.000900%-0.00900%, 0.000900%-0.00200%, 0.000900%-0.00300%, 0.000900%-0.00400%, 0.00100%-0.00200%, 0.00100%-0.00300%, 0.00100%-0.00400%, 0.00200%-0.00300%, 0.00200%-0.00400%, 0.00300%-0.00400% or more water insoluble nitrogen.

While the fertilizer can be comprised of both water soluble and water insoluble nitrogen, most of the total nitrogen can be water soluble nitrogen. The fertilizer can be composed of at least about: 98.00%, 98.25%, 98.50%, 98.75%, 99.00%, 99.25%, 99.50%, 99.75%, 99.99% or more of nitrogen that is water soluble. Alternatively, the fertilizer can be composed of at least about: 98.0%-98.25%, 98.00%-98.50%, 98.00%-98.75%, 98.00%-99.00%, 98.00%-99.25%, 98.00%-99.50%, 98.00%-99.75%, 98.00%-99.99%, 98.25%-98.50%, 98.25%-98.75%, 98.25%-99.00%, 98.25%-99.25%, 98.25%-99.50%, 98.25%-99.75%, 98.25%-99.99%, 98.50%-98.75%, 98.50%-99.00%, 98.50%-99.25%, 98.50%-99.50%, 98.50%-99.75%, 98.50%-99.99%, 98.75%-99.00%, 98.75%-99.25%, 98.75%-99.50%, 98.75%-99.75%, 98.75%-99.99%, 99.00%-99.25%, 99.00%-99.50%, 99.00%-99.75%, 99.00%-99.99%, 99.25%-99.50%, 99.25%-99.75%, 99.25%-99.99%, 99.50%-99.75%, 99.50%-99.99%, 99.75%-99.99% or more nitrogen that can be water soluble.

The high water solubility of nitrogen is an important feature of the fertilizer because plant systems often need quick access to nitrogen in order for plant uptake. This feature is particularly important for hydroponic media and aeroponic systems, where the solubility of micro- and macronutrients is critical for plant intake.

The composition of the fertilizer can be comprised of at least about: 0.00100%, 0.00125%, 0.00150%, 0.00175%, 0.00200%, 0.00225%, 0.00250%, 0.00275%, 0.00300%, 0.00325%, 0.00350%, 0.00375%, 0.00400%, 0.00425%, 0.00450%, 0.00475%, 0.00500%, 0.00525%, 0.00550%, 0.00575%, 0.00600% or more of available phosphate (P2O5). Alternatively, the composition of the fertilizer can be comprised of at least about: 0-0.00100%, 0.00100%-0.00125%, 0.00100%-0.00150%, 0.00100%-0.00175%, 0.00100%-0.00200%, 0.00100%-0.00225%, 0.00100%-0.00250%, 0.00100%-0.00275%, 0.00100%-0.00300%, 0.00125%-0.00150%, 0.00125%-0.00175%, 0.00125%-0.00200%, 0.00125%-0.00225%, 0.00125%-0.00250%, 0.00125%-0.00275%, 0.00125%-0.00300%, 0.00150%-0.00175%, 0.00150%-0.00200%, 0.00150%-0.00225%, 0.00150%-0.00250%, 0.00150%-0.00275%, 0.00150%-0.00300%, 0.00175%-0.00200%, 0.00175%-0.00225%, 0.00175%-0.00250%, 0.00175%-0.00275%, 0.00175%-0.00300%, 0.00200%-0.00225%, 0.00200%-0.00250%, 0.00200%-0.00275%, 0.00200%-0.00300%, 0.00225%-0.00250%, 0.00225%-0.00275%, 0.00225%-0.00300%, 0.00250%-0.00275%, 0.00250%-0.00300%, 0.00275%-0.00300% or more available phosphate (P2O5).

The composition of the fertilizer can be comprised of at least about: 0.0300%, 0.0400%, 0.0500%, 0.0600%, 0.0700%, 0.0800%, 0.0900%, 0.100%, 0.200%, 0.300% or more of available K20 or potash. Alternatively, the composition of the fertilizer can be comprised of at least about: 0%-0.0300%, 0.0300%-0.0400%, 0.0300%-0.0500%, 0.0300%-0.0600%, 0.0300%-0.0700%, 0.0300%-0.0800%, 0.0300%-0.0900%, 0.0300%-0.100%, 0.0300%-0.200%, 0.0300%-0.300%, 0.0400%-0.0500%, 0.0400%-0.0600%, 0.0400%-0.0700%, 0.0400%-0.0800%, 0.0400%-0.0900%, 0.0400%-0.100%, 0.0400%-0.200%, 0.0400%-0.300%, 0.0500%-0.0600%, 0.0500%-0.0700%, 0.0500%-0.0800%, 0.0500%-0.0900%, 0.0500%-0.100%, 0.0500%-0.200%, 0.0500%-0.300%, 0.0600%-0.0700%, 0.0600%-0.0800%, 0.0600%-0.0900%, 0.0600%-0.100%, 0.0600%-0.200%, 0.0600%-0.300%, 0.0700%-0.0800%, 0.0700%-0.0900%, 0.0700%-0.100%, 0.0700%-0.200%, 0.0700%-0.300%, 0.0800%-0.0900%, 0.0800%-0.100%, 0.0800%-0.200%, 0.0800%-0.300%, 0.0900%-0.100%, 0.0900%-0.200%, 0.0900%-0.300%, 0.100%-0.200%, 0.100%-0.300%, 0.200%-0.300% or more available K2O or potash.

In some embodiments, the fertilizer can be applied as a foliar spray. In this manner, the fertilizer can be used as a liquid fertilizer and can be applied to a plant by spraying the fertilizer directly to a plant's leaves. Thereby, plant adsorption can take place through the plant's stomata and/or the plant's epidermis.

The term “foliar spray” is to be broadly construed, and it is understood that the term includes, but is not limited to, applying fertilizer that is liquid in nature directly to the leaves, shoots, and/or stems of a plant.

What is claimed is:

1. A method of making a fertilizer comprising the steps of:
(a) depositing organic matter and water into an anaerobic digester system;
(b) allowing anaerobic digestion to occur;
(c) separating a liquid digestate from a solid digestate;
(d) heating said liquid digestate wherein said liquid digestate reaches its boiling point temperature;
(e) filtering said liquid digestate;
(f) applying said liquid digestate to plant roots, stems, shoots, leaves or any plant media.

2. The method of claim 1, wherein said liquid digestate is heated to 100° C.-120° C.

3. The method of claim 2, wherein said liquid digestate is heated from 20 minutes to 30

4. The method of claim 1, wherein said liquid digestate is separated from said solid digestate by decantation.

5. The method of claim 4, wherein said liquid digestate is decanted from said solid digestate by using a pump.

6. The method of claim 1, wherein said fertilizer contains 98.00%-99.99% water soluble nitrogen.

7. The method of claim 1, wherein said fertilizer is applied to plants as a foliar spray.

8. The method of claim 1, wherein said fertilizer is produced by placing organic matter in said anaerobic digester system and removing organic matter from said anaerobic digester after 60 days to 75 days.

9. The method of claim 1, wherein organic matter is food waste and animal manure in a 3:1 ratio.

10. The method of claim 9, wherein animal manure is pig manure and cow manure in a 4:1 ratio.

11. A method of making a fertilizer comprising the steps of:
(a) depositing organic matter and water into an anaerobic digester system, wherein said digester system is comprised of parts and features comprising:
(i) a digester body that house a drum or a set of drums,
(ii) said drum configured to receive organic matter,
(iii) said drums coupled to one another and movable along a length of said digester body
(b) allowing anaerobic digestion to occur;
(c) separating a liquid digestate from a solid digestate;
(d) heating said liquid digestate wherein said liquid digestate reaches its boiling point temperature;
(e) filtering said liquid digestate;
(f) applying said liquid digestate to plant roots, stems, shoots, leaves or any plant media.

12. The method of claim 11, wherein said liquid digestate is heated to 100° C.-120° C.

13. The method of claim 12, wherein said liquid digestate is heated from 20 minutes to 30 minutes.

14. The method of claim 11, wherein said liquid digestate is separated from said solid digestate by decantation.

15. The method of claim 14, wherein said liquid digestate is decanted from said solid digestate by using a pump.

16. The method of claim 11, wherein said fertilizer contains 98.00%-99.99% water soluble nitrogen.

17. The method of claim 11, wherein said fertilizer is applied to plants as a foliar spray.

18. The method of claim 11, wherein said fertilizer is produced by placing organic matter in said anaerobic digester system and removing organic matter from said anaerobic digester after 60 days to 75 days.

19. The method of claim 11, wherein organic matter is food waste and animal manure in a 3:1 ratio.

20. The method of claim 19, wherein animal manure is pig manure and cow manure in a 4:1 ratio.
